(19) United States
(12) Patent Application Publication
(10) Pub. No.: US 2007/0133597 A1
(43) Pub. Date: Jun. 14, 2007

(54) Method and network management system for service-oriented planning and expansion of a communication network

(75) Inventor: Michael Frantz, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/634,036

(22) Filed: Dec. 5, 2006

(30) Foreign Application Priority Data
Dec. 13, 2005 (EP) 05112020.2

(51) Int. Cl. H04J 3/22

(52) U.S. Cl. 370/465; 370/401

(57) ABSTRACT

In one aspect, a method for a service-oriented planning and expansion of a communication network is provided. In the communication network a new service with all the data necessary for it is defined in a network management system. A check is made, based on a model of the already installed communication network and with reference to rules defined for an expansion of the communication network, as to whether it is possible to execute the new service in the communication network. If the new service cannot be executed in the previously installed communication network, a model of the communication network expanded by the network elements, network element components or connections necessary for execution of the new service is generated by the network management system, based on which the installed communication network can be expanded for the new service. This expanded model of the communication network is then displayed.

### CROSS REFERENCE TO RELATED APPLICATIONS

This application claims priority of European application No. 05112020.2 EP filed Dec. 13, 2005, which is incorporated by reference herein in its entirety.

### FIELD OF INVENTION

The invention relates to a method for service-oriented planning and expansion of a communication network comprising network elements, connections between the network elements and also a network management system and in which a new service with all the data necessary for it is defined in the network management system. This involves setting up the network management system for administration and configuration of the network elements, the connections and the services as well as for executing the inventive method.

### BACKGROUND OF INVENTION

By definition a communication network is understood as a generic term for all resources through which network access points remote from one another are connected and by which services with service features are made available to these access points for communication purposes and for transmission of data.

A communication network typically comprises a plurality of different network elements or network element types—such as switches, routers, bridges, hubs, gateways, etc. for example. These network elements are connected to each other by means of (physical) connections via which, depending on configuration of the communication network concerned, data is exchanged between the network elements with different capacities and different bandwidth.

In addition each network element can also comprise what are known as network element components, such as processors, network cards for establishing a physical connection to the network via a suitable access method, ports for connecting network elements to each other or for connecting terminals to the network element. The number and also the configuration of these network components is determined for example by the type of network element concerned, the services offered in the communication network, the required quality of service, the required availability of the communication network, etc.

Planning, structure and dimensioning of a communication network is undertaken using traffic theory methods. Traffic theory, which is a subdiscipline of communication and switching technology, deals with original characteristics of data traffic in a communication network (e.g. delay times, operating times, losses, call duration and their statistical distribution, etc.) as well as how they are affected by switching and network technology devices (i.e. with the resources made use of by data traffic such as network elements and connections), with the data traffic in a communication network being for example dependent on the number of users as well as the services offered.

Operation and maintenance of communication networks, especially of large telecommunication networks or computer networks, is undertaken by network management systems, with network management systems being defined as the generic term for the management of network elements as well as the associated network element components, of connections between the network elements and of services in a communication network.

Functions such as the initial planning of the communication network, the advance determination of the traffic routing, the configuration management, the error management and the safety management, the ongoing polling of the status of the network element, etc. are made available to a communication network by the network management system. With the aid of the network management system it is also possible to set up services, for communication purposes or for transmission of data, which make use of a number of network elements. What is known as an element management system can be used for this purpose, with which appropriate attributes can be set up in each network element needed for the service. The element management system in this case represents a supplementary component to the network management system, with which the individual network elements or network element types can be configured and administered. The connections between the network elements are then established and administered with the network management system.

Data about the physically available resources (network element or connections) as well as their configuration is for example either learned automatically by the network management system or is entered into the network management system, in order to be stored there in an internal network management system database for example. In this way all network elements as well as the entire topology of the installed communication network are known to the network management system.

Based on the data available in the network management system about the network elements and the topology of the communication network, a model of the installed communication network can be generated by the network management system. This model can then be used for example to simplify the process of configuration and also monitoring of the communication network.

The model of the communication network can also be used for configuration of services used for communication purposes or of services for transmission of data. This is because some network management systems can for example display the installed communication network with its network elements and connections on the basis of this model.

This means that for example it is also possible to use the model for the configuration of a new service. To set up this service, those network elements and connections which are used by the service can then for example be selected in the model of the installed communication network displayed by the network management system, and in this way all the data necessary for the service can be defined in the network management system.

Introduction of new services, for communication purposes or for the transmission of data, or an increasing number of users can for example make an expansion of the communication network with new resources (network elements, network components or connections) necessary so that the communication network provides the required availability and quality of service. Especially with communication networks, such as Carrier Grade Ethernet Networks, SDH networks or ATM networks, for which a very high level of availability is demanded, it is important to identify those resources (network elements, network element components or connections) by which the communication network must be expanded when a new service is introduced.

Network management systems can in fact be used for the definition of new services, which is also possible if for example not all necessary resources for a new service (network elements, network element components or connections) are present in the installed communication network. Since however the model of the installed communication network displayed by it is based for example on data stored in an internal database of the network management system for the resources (network elements, network element components or connections)—meaning that it is a statistical model, in most cases no information can be provided by the network management system for definition of a new service relating to whether additional resources (network elements network element components or connections) are needed or not in the communication network for the new service.

### SUMMARY OF INVENTION

The introduction and activation of a new service (i.e. the configuration of the service in the installed communication network) is then generally executed at a later point in time after for example all necessary resources have been installed in the communication network. These new, additional resources (network elements, network element components or connections) are mostly for example identified and specified by time-consuming network planning generally undertaken offline. The data of the additional resources identified in the network planning process must then also be entered, e.g. manually into the network management system, so that these new resources which will mostly only be installed in the communication network before the new services are activated are displayed at least in the model of the communication network presented by the network management system and will thereby be available for the new service.

An object underlying the present invention is thus to specify a method as well as a network management system through which, after the definition of a new service, it is automatically established which additional resources (network elements, network element components or connections) are needed to expand the communication network accordingly for the execution of the new service.

The object is achieved by a method of the type specified at the start of this document, in which the definition of a new service is based on a model of the already installed communication network in the network management system and with reference to rules defined for an expansion of the communication network, a check is undertaken as to whether it is possible to execute the new service in the communication network, then a model of the communication network expanded by the network elements, network element components or connections necessary for the execution of the new service is generated, on the basis of which the installed communication network is set up for a new service and this expanded model of the communication network is then displayed.

A main aspect of the proposed inventive solution consists of, starting from the model of the already installed communication network and based on the rules defined for the expansion by the network management system, automatically checking whether a new service can be executed in the communication network or not. If it is established in this case that an expansion of the communication network is necessary, a model expanded by a possible communication network configuration is generated and presented by the network management system. This provides a simple way of shortening and simplifying the network planning process since, in the expanded model for example, the changes to the topology of the communication network or expansions necessary for the new service by new network elements or network element components are visible. In addition the inventive method enables the planning of expansions of the communication network to be optimized in an advantageous manner, since the corresponding configuration of the communication network is determined on the basis of the stored model and is available in the network management system.

It is useful if rules for a configuration of new network elements are specified as defined rules for the expansion of the communication network, since the configuration for new network elements can also be determined at the same time for the determination of the expanded model of the communication network.

It is advantageous for rules for an equipping of network elements with new network element components to be specified as defined rules for the expansion of the communication network, since on determination of the expanded model of the communication network any modifications of the configuration of network elements which may be needed (e.g. exchange of network element components—such as replacement of a network card by a faster network card or by a card with more connection options, installation of further network components, etc.) can be displayed.

Furthermore it is recommended for defined rules for the expansion of the communication network to be specified as rules for the connections between the network elements, since this provides a simple method of determining whether for example new connections are to be inserted between the network elements—i.e. whether for example the network elements have the necessary port facilities for the new connection.

A worthwhile further development of the invention provides for the automatic creation of a work order for the necessary expansions of the communication network on the basis of the expanded model of the communication network, since, on the basis of the expansions determined in network management, which are also already stored for example in internal network management database, this saves time by allowing work orders for installations or modifications of network elements or connections to be generated in the communication network.

In a preferred development of the invention each suitable expanded model of the communication network for the execution of the new services is presented, which advantageously enables all expansion options and thereby the best configuration option for the communication network to be established without time-consuming manual network planning processes.

It is advantageous if, when all network elements, network element components or connections between the network elements are available for executing the new service, the new service is created and activated automatically, since this dispenses with multiple input of configuration and routing data for the definition of the service. This means that the new service can be created and activated immediately on the basis of the data entered in the network management system, as soon as it is evident that all the resources necessary for the service are installed and are thereby physically available in the communication network.

In addition the object is also achieved by a network management system for administration and configuration of the network elements, the connections and the services which is additionally set up to execute the inventive method and thus comprises means for making checks on the basis of a model of the already installed communication network, means for making checks on the basis of defined rules for the expansion of the communication network, means for generating a model of the communication network expanded by the necessary network elements, network element components and connections for the new service on the basis of which the installed communication network can be expanded for the new service, and means for presenting each expanded model of the communication network suitable for executing the new service.

This embodiment of the network management system provides an improvement in that, on the basis of the data present in the network management system (e.g. model of the installed communication network, definition of the new service) it can be automatically established whether the new service can be executed by the installed communication network. In addition expansions necessary for the service are detected and displayed in the form of an expanded model of the communication network, which greatly simplifies the network planning process.

It is of further advantage if means for entering and storing the defined rules for expansion of the communication network are provided, since this offers a simple way of defining and adapting the rules in network management if for example new network elements, network components or connections are inserted into the communication network.

It is also expedient for means to be provided for automatic creation of work orders for the necessary expansions of the communication network based on the expanded model of the communication network, as well as means for automatic setup of the new service, since this allows work orders for expanding the communication network to be derived in a simple manner from the transferred, expanded model of the communication network, and after the expansions to the communication network have been completed, for the new service to be set up immediately. This means that repeating the entry of the definition of the new service in the network management system after the installation of for example new network elements, network element components or connections—provided an expansion for the new service is needed at all—is no longer necessary.

### BRIEF DESCRIPTION OF THE DRAWINGS

The invention is explained in greater detail by examples below with reference to the enclosed Figures. The Figures show:

FIG. 1 a schematic diagram of a network management system for executing the inventive method

FIG. 2 the schematic execution sequence of the inventive method for service-oriented planning and expansion of a communication network

### DETAILED DESCRIPTION OF INVENTION

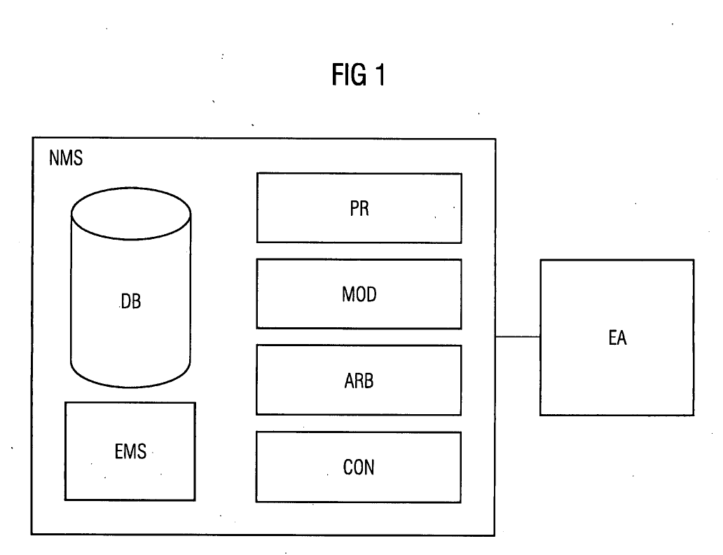

FIG. 1 shows a schematic diagram of the functional structure of a network management system NMS for executing the inventive method, with the diagram only showing those functional components which are used for executing the inventive method.

In addition to other functional components not explicitly shown in the diagram, such as configuration management, security management, error management, polling network elements statuses etc., the network management system NMS comprises an element management system EMS, with the aid of which individual network elements can be configured and administered.

The configuration of individual network elements defined by means of the element management system EMS is stored in a database DB of the network management system. In addition to the data of the network elements physically present, data about the connections between the network elements as well as about the configuration of network elements and connections is held in this database DB. This data is either learned by the network management system NMS or entered via the input/output unit EA.

All the data necessary for a new service—such as bandwidth required, routing options etc. is also entered via the input/output unit EA.

To check whether the new service can be executed in the installed communication network, a checking unit PR is made available by the network management system NMS. The checking unit PR checks on the basis of a model of the already installed communication network and with reference to rules defined for expansion of the communication network, whether the resources necessary for the service are available. The defined rules for the expansion of the communication network are also entered via the input/output unit EA and stored in the database DB.

The model of the already installed communication network is generated on the basis of the data stored in the database DB of the network management system NMS from network elements and from the topology of the communication network by a model generating unit MOD. The model of the communication network expanded by the network elements, network element components or connections needed for the execution of the new service is also created with the aid of the model generating unit MOD. The input/output unit EA is again included for the presentation of the model and to display the possible expansion variants of the communication network for the new service.

To create the work orders for the necessary expansion of the communication network the network management system NMS contains a work order creation unit ARB.

Furthermore a service creation device CON is provided in the network management system NMS, a means of which the services are automatically set up and activated if all the resources necessary for execution (network elements, network element components and connections) are present in the installed communication network.

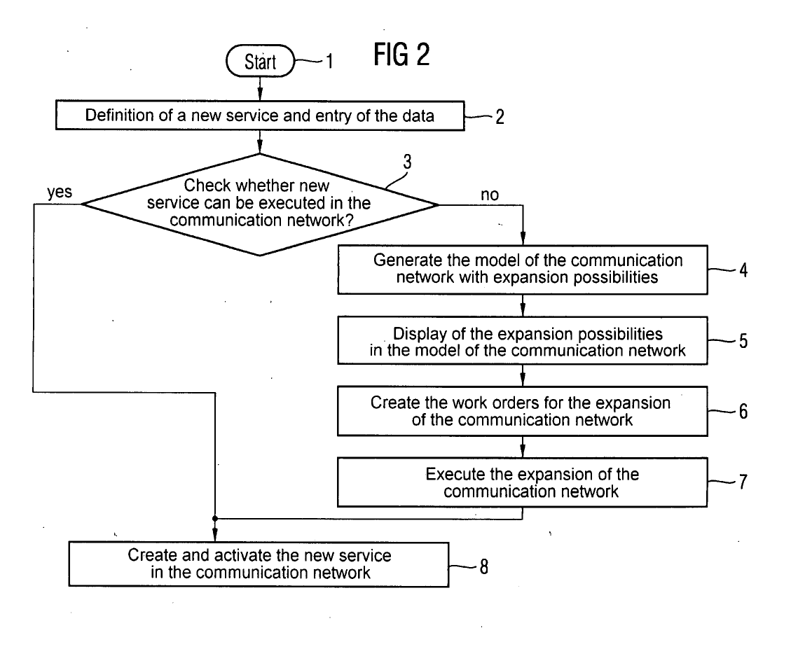

FIG. 2 shows the schematic execution sequence of the inventive method for service-oriented planning and expansion of a communication network.

After a first start step 1 a new service is defined in a second step 2 and all data necessary for this service (e.g. required bandwidth, routing options, etc.) is input via the input/output unit EA of the network management system NMS. After the data has been input, a check is made in a third step 3 as to whether the new service can be executed with the available resources in a communication network. In this case a check is first made by the checking unit PR on the basis of the model of the installed communication network as to whether the necessary resources are available for the new service and as to whether for example the required bandwidth can be made available for the service.

If it is established in the third step 3 that all necessary resources are present in the installed network, in a last step 8 the new service is automatically set up and activated with the aid of the network management system NMS.

If however it is established in the third step 3 that the new service cannot be executed in the communication network already physically available, a check is made on the basis of defined rules by the network management system NMS as to how the communication network can be expanded to execute the service. For example the following rules can be defined for expansion of the communication network:
Expansion by a new network element is always possible
Expansion by a new connection between the network elements is only possible depending on the network element type and available connection ports at the network element and the free connections between the network elements—such as free glass fibers for example
Insertion of new network element components such as network cards for example is only possible if free mounting locations are still available in the network elements.
Replacement of network element components—such as replacing a network card by a faster network card—can only be executed if the new network element component is supported by the network element.

In a fourth step 4 the possible expansion variants for executing the new service will then be determined by the model generating unit MOD of the network management system NMS on the basis of the model of the already installed communication network and using the defined rules for expansion of the communication network. An expanded model of the communication network is then also generated by the model generating unit by the possible expansions needed for the new service or possible for a number of variants—such as new network elements, new network element components, replaced network element components or new connections between network elements for example—being made visible.

In a fifth step 5 the expanded model of the communication network is then output with the aid of the input/output unit EA of the network management system NMS and is presented so that the desired expansion of the communication network can then be selected by the user. If the proposed expansion or, where there are a number of variants, a specific expansion option in the expanded model of the communication network is selected by the user, the new resources (network elements, network components, connections) are automatically stored in the network management system NMS with the status “planned”. The new service can now be created by the network management system NMS in the “planned” status of the new service using already installed resources and the new resources planned.

In a sixth step 6, on the basis of the expansion proposal for the communication network selected in the expanded model, work orders can be created by the order creation unit ARB of the network management system NMS, for example to order specific network element components, installation orders for network elements etc.

In a seventh step 7 the actions necessary for the expansion of the communication network are then performed. After completion of these expansions, the new service is set up and activated in an eighth and last step 8 in the communication network, with the status of the service as well as the new resources also being set to “installed”.

1-10. (canceled)

11. A method for service-oriented planning and expansion of a communication network, with the network comprising network elements, network element components, connections between the network elements and a network management system for administration and configuration of the network elements, components, the connections and the services, comprising:
defining a new service in the network management system;
checking a possibility to execute the new service in the communication network based on a model of the communication network as installed in the network management system and with reference to rules defined for an expansion of the communication network;
generating an expanded model of the communication network expanded by an item needed for execution of the new service, the item selected from the group comprising of network element, network element component, connection, and combinations thereof; and
displaying the expanded model of the communication network.

12. The method as claimed in claim 11, wherein the rules include a rule for a configuration of a new network element.

13. The method as claimed in claim 12, wherein a work order for the necessary expansions of the communication network is automatically created on the basis of the expanded model of the communication network.

14. The method as claimed in claim 11, wherein the rules include a rule for equipping a network element with a new network element component.

15. The method as claimed in claim 14, wherein a work order for the necessary expansions of the communication network is automatically created on the basis of the expanded model of the communication network.

16. The method as claimed in claim 11, wherein the rules include a rule for a connection between the network elements.

17. The method as claimed in claim 16, wherein a work order for the necessary expansions of the communication network is automatically created on the basis of the expanded model of the communication network.

18. The method as claimed in claim 11, wherein a work order for the necessary expansions of the communication network is automatically created on the basis of the expanded model of the communication network.

19. The method as claimed in claim 11, wherein each expanded model of the communication network suitable for executing the new service is displayed.

20. The method as claimed in claim 11, wherein if all the network elements, network element components or connections between the network elements needed for executing the new service are available, the new service is automatically set up and activated

21. A network management system, for service-oriented planning and expansion of a communication network, comprising:
a checking unit that performs checks for a new service to be added to the communication network, wherein the checks are based on a model of the communication network and with reference to defined rules for the expansion of the communication network based on the new service;
a model generating unit that generates a model of the communication network based on expanding the installed communication network for the new service, the expanded communication network expanded by an item needed for execution of the new service, the item selected from the group consisting of network element, network element component, connection and combinations thereof; and
an input/output unit that presents each expanded model of the communication network suitable for executing the new service.

22. The network management system as claimed in claim 21, further comprises a database for storing the defined rules for the expansion of the communication network, wherein the input/output unit allows input for the rules to be stored in the database.

23. The network management system as claimed in claim 22, further comprises:
a work order creation unit for automatic creation of work orders for the necessary expansion of the communication network based on the expanded model of the communication network; and
a service creation device that provides for an automatic creation of the new service.

24. The network management system as claimed in claim 23,
wherein the rules include a rule for a configuration of a new network element or
wherein the rules include a rule for equipping a network with a new network element component or
wherein the rule include a rules for a connection between the network elements.

25. A method for service-oriented planning and expansion of a communication network, comprising:
defining a new service in the network management system;
checking a possibility to execute the new service in the communication network based on a model of the communication network in the network management system as installed;
generating an expanded model of the communication network expanded by an item needed for execution of the new service when it is not possible to execute the new service on the installed communication network, the item selected from the group comprising of network element, network element component, connection, and combinations thereof; and generation of the expanded model based on rules defined for the expansion of the communication network; and
automatically activating the new service if possible to execute the new service in the communication network.

26. The method as claimed in claim 25, wherein a work order for the necessary expansions of the communication network is automatically created on the basis of the expanded model of the communication network.

27. The method as claimed in claim 26, wherein each expanded model of the communication network suitable for executing the new service is displayed.

28. The method as claimed in claim 26, wherein after the service order has been carried out, it is possible to execute the new service in the communication network, thereby the service is automatically activated.
